(19) United States
(12) Patent Application Publication
(10) Pub. No.: US 2026/0251839 A1
(43) Pub. Date: Aug. 27, 2026

(54) OPTICAL DEVICE AND DISPLAY SYSTEM

(71) Applicant: Coretronic Corporation, Hsin-Chu (TW)

(72) Inventors: Po-Han Chiu, Hsin-Chu (TW); Ming-Dah Liu, Hsin-Chu (TW); Hung-Tse Lin, Hsin-Chu (TW); Chao-Hung Weng, Hsin-Chu (TW); Kuan-Wen Liu, Hsin-Chu (TW)

(73) Assignee: Coretronic Corporation, Hsin-Chu (TW)

(21) Appl. No.: 19/539,028

(22) Filed: Feb. 13, 2026

(30) Foreign Application Priority Data
Feb. 21, 2025 (CN) 202510192956.4

(51) Int. Cl. F21V 8/00

(52) U.S. Cl. CPC G02B 6/0053

(57) ABSTRACT

An optical device and a display system are provided. The optical device includes a plurality of first strip-shaped optical microstructures and a plurality of second strip-shaped optical microstructures. Top surfaces of the first strip-shaped optical microstructures form a first optical surface. Each first strip-shaped optical microstructure has a first center line. A first height difference is provided between a highest position and a lowest position of each first center line, or a first difference is provided between the highest positions of any two of the first center lines. Top surfaces of the second strip-shaped optical microstructures form a second optical surface. Each second strip-shaped optical microstructure has a second center line. A second height difference is provided between a highest position and a lowest position of each second center line, or a second difference is provided between the highest positions of any two of the second center lines.

### CROSS-REFERENCE TO RELATED APPLICATION

This application claims the priority benefit of China application serial no. 202510192956.4, filed on Feb. 21, 2025. The entirety of the above-mentioned patent application is hereby incorporated by reference herein and made a part of this specification.

### BACKGROUND

### Technical Field

The disclosure relates to an optical device and a display system.

### Description of Related Art

Optical sheets with diffusion functions, such as optical sheets with surface structures like micro lens arrays (MLAs), prism arrays, etc., have high design freedom depending on different application scenarios. Further, in the production of optical sheets, ultra-precision processing or laser direct writing processes may be used to make molds. Next, through hot pressing, UV light curing, and other embossing processes, the special optical structures on the molds may be embossed to the surfaces of the optical sheets. In this way, mass production, cost reduction, and extensive application in the optical systems are achieved.

For instance, an optical sheet formed by a micro lens array may be used as the projection screen for a head-up display, a laser projector, etc. The head-up display or the laser projector may project an image light beam onto the optical sheet, and the image light beam has a larger divergence angle after passing through the optical sheet, so that a user may see the image in a wider viewing range.

However, when the optical sheet is used as a projection screen, in order to avoid the moiré patterns, microstructures smaller than the pixels of the projection image are required to improve the image uniformity. However, the arrangement of smaller and denser microstructures will also produce diffraction phenomena, and in practical applications, the light distribution that causes light diffusion is prone to produce uneven interference fringes or diffraction speckles.

In the related art, there are two approaches to solve the above problems. One is to roughen the surface of the optical sheet or add scattering particles to the optical sheet, but this may easily cause defects on its surface, leading to impact on image quality. Further, optical efficiency is considerably lowered, and the diffusion range of scattered light rays cannot be effectively controlled. The other approach is to independently change the parameters of each micro lens on the optical sheet. For instance, the height, position, curvature, etc. of each micro lens on the optical sheet is randomly distributed to destroy the structural periodicity and lower the diffraction effect. However, the design method of independently controlling the structural parameters of each micro lens is complex and difficult to process.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, part of, or all of the above objectives or other objectives, an embodiment of the disclosure provides an optical device. The optical device has a first optical surface and a second optical surface. The optical device includes a plurality of first strip-shaped optical microstructures and a plurality of second strip-shaped optical microstructures. The first strip-shaped optical microstructures extend in a first direction. Top surfaces of the first strip-shaped optical microstructures form the first optical surface. Each of the first strip-shaped optical microstructures has a first center line. A first height difference is provided between a highest position and a lowest position of each first center line, or a first difference is provided between the highest positions of any two of the first center lines. The second strip-shaped optical microstructures extend in a second direction. Top surfaces of the second strip-shaped optical microstructures form the second optical surface. The first direction and the second direction are not parallel. Each of the second strip-shaped optical microstructures has a second center line. A second height difference is provided between a highest position and a lowest position of each second center line, or a second difference is provided between the highest positions of any two of the second center lines.

In order to achieve one, part of, or all of the above objectives or other objectives, an embodiment of the disclosure provides a display system. The display system includes a projection device and an optical device. The projection device is configured to provide a projection light beam, and the optical device is arranged on a transmission path of the projection light beam.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1A is a block diagram of a display system according to an embodiment of the disclosure.

FIG. 1B is a schematic diagram of an application of the display system according to an embodiment of the disclosure.

FIG. 2A is a schematic view of an optical device of FIG. 1A and FIG. 1B.

FIG. 2B is an enlarged schematic view of a first optical surface or a second optical surface of the optical device of FIG. 2A.

FIG. 3A to FIG. 3D are schematic views of forming a mold of the optical device of FIG. 2A by cutting with a tool.

FIG. 3E and FIG. 3F are graphs of intensity distribution of diffused light with different lens radii.

FIG. 3G is a schematic graph of a profile of another optical device of FIG. 1A and FIG. 1B.

FIG. 3H is a graph of distribution of diffused light shapes of the optical device of FIG. 3G.

FIG. 4A, FIG. 5A, and FIG. 6A are top views of the various optical devices of FIG. 1A and FIG. 1B.

FIG. 4B, FIG. 5B, and FIG. 6B are bottom views of the various optical devices of FIG. 1A and FIG. 1B.

FIG. 4C, FIG. 5C, and FIG. 6C are simulation graphs of illuminance distribution of the various optical devices of FIG. 1A and FIG. 1B.

FIG. 7 to FIG. 9 are schematic views of structures of optical devices according to different embodiments of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

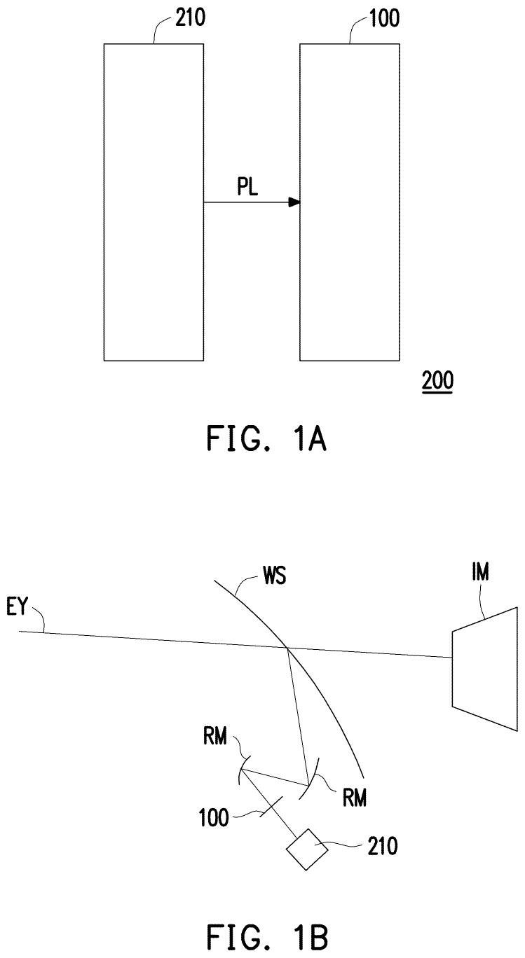

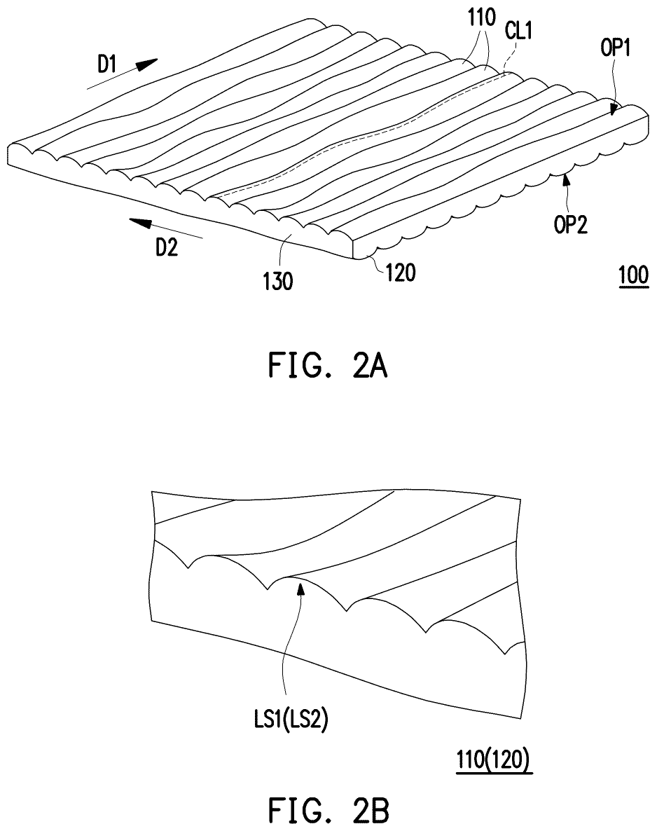

FIG. 1A is a block diagram of a display system according to an embodiment of the disclosure. FIG. 1B is a schematic diagram of an application of the display system according to an embodiment of the disclosure. FIG. 2A is a schematic view of an optical device of FIG. 1A. FIG. 2B is an enlarged schematic view of a first optical surface or a second optical surface of the optical device of FIG. 2A. Referring to FIG. 1A to FIG. 2B, a display system 200 includes a projection device 210 and an optical device 100. The projection device 210 is, for example, a projector including a light source module (e.g., light emitting elements (light emitting diode or laser diode), lens, dichroic mirror, prism, wavelength conversion element, and/or homogenizer), an image module (e.g., light valve, digital micro-mirror device, or liquid crystal display panel), and a projection lens module, and is configured to provide a projection light beam PL. The optical device 100 is arranged on a transmission path of the projection light beam PL and is, for example, a projection film. In an embodiment, the display system 200 is, for example, a head-up display, and as shown in FIG. 1B, the display system 200 is arranged in a vehicle. The projection light beam PL provided by the display system 200 is transmitted to a human eye EY of the driver through a plurality of optical elements (e.g., a reflection mirror RM) and a windshield WS, so that the driver may see a virtual image IM in front. In another embodiment, the display system 200 is, for example, a projection display system. To be specific, the optical device 100 has a first optical surface OP1, a second optical surface OP2, a plurality of first strip-shaped optical microstructures 110, a plurality of second strip-shaped optical microstructures 120, and an optical film substrate 130. As shown in FIG. 2A and FIG. 2B, in this embodiment, the first strip-shaped optical microstructures 110 are arranged on a surface of the optical film substrate 130. The first strip-shaped optical microstructures 110 extend in a first direction D1. The second strip-shaped optical microstructures 120 are arranged on another surface of the optical film substrate 130. The two surfaces of the optical film substrate 130 are opposite to each other (the two surfaces are not connected, for example, the two surfaces are parallel). The second strip-shaped optical microstructures 120 extend in a second direction D2. The first direction D1 and the second direction D2 are not parallel. For instance, in this embodiment, the first direction D1 and the second direction D2 are orthogonal to each other. Further, top surfaces of the first strip-shaped optical microstructures 110 form the first optical surface OP1, and top surfaces of the second strip-shaped optical microstructures 120 form the second optical surface OP2. Further, the projection light beam PL enters the optical device 100 through, for example, the first optical surface OP1 or the second optical surface OP2. An incident angle of the projection light beam PL incident on the optical device 100 is, for example, greater than or equal to 70 degrees and less than or equal to 110 degrees (for example, a virtual plane is parallel to the first direction D1 and the second direction D2, and an angle between the projection light beam PL and the virtual plane is, for example, greater than or equal to 70 degrees and less than or equal to 110 degrees).

Further, as shown in FIG. 2A and FIG. 2B, in this embodiment, cross sections of the top surfaces of the first strip-shaped optical microstructures 110 on a first plane orthogonal to the first direction D1 are first lens surface profiles LS1, and cross sections of the top surfaces of the second strip-shaped optical microstructures 120 on a second plane orthogonal to the second direction D2 are second lens surface profiles LS2. At least one of the first lens surface profiles LS1 and the second lens surface profiles LS2 is an arc, a parabola, or a free curve.

In this embodiment, each of the first strip-shaped optical microstructures 110 has a first center line CL1, and each of the second strip-shaped optical microstructures 120 has a second center line CL2. Each first center line CL1 (each second center line CL2) of each first strip-shaped optical microstructure 110 (each second strip-shaped optical microstructure 120) is, for example, a line of symmetry when viewing the first strip-shaped optical microstructure 110 (the second strip-shaped optical microstructure 120) from above (in a direction perpendicular to both the first direction D1 and the second direction D2), without considering the influence of adjacent strip-shaped optical microstructures on a shape of each first strip-shaped optical microstructure 110. A first height difference is provided between a highest position and a lowest position of the first center line CL1 (or a second height difference is provided between a highest position and a lowest position of the second center line CL2). Alternatively, a first difference is provided between the highest positions of the first center lines CL1 of any two of the first strip-shaped optical microstructures 110 (or a second difference is provided between the highest positions of the second center lines CL2 of any two of the second strip-shaped optical microstructures 120). This means that the first strip-shaped optical microstructures 110 and the second strip-shaped optical microstructures 120 have ups and downs. In an embodiment, at least one of the first height difference and the first difference is greater than or equal to a predetermined value, and at least one of the second height difference and the second difference is greater than or equal to the predetermined value. To be specific, in this embodiment, the predetermined value is λ/[4(n−1)], for example, where λ is a minimum working wavelength of light preset to pass through the optical device 100, and n is an equivalent refractive index of each of the first strip-shaped optical microstructures 110 or each of the second strip-shaped optical microstructures 120. Further, in this embodiment, the predetermined value may range between λ/[4(n−1)] and 4λ/(n−1). For instance, in this embodiment, the main working wavelength of the light passing through the optical device 100 is in the visible light band, between 400 nm and 760 nm. Therefore, in this embodiment, λ is approximately 400 nm.

In this embodiment, the first center line CL1 of any first strip-shaped optical microstructure 110 is its ridge line, and the second center line CL2 of any second strip-shaped optical microstructure 120 is also its ridge line. The ridge line of any first strip-shaped optical microstructure 110 and the ridge line of any second strip-shaped optical microstructure 120 are function curves formed by superimposing one or a plurality of sine functions or non-periodic function curves. Herein, the ridge line refers to the connection of the highest positions of the strip-shaped optical microstructure on an optical surface. Further, as shown in FIG. 2A, in this embodiment, the ridge lines of adjacent first strip-shaped optical microstructures 110 are different, and the ridge lines of adjacent second strip-shaped optical microstructures 120 are also different. Herein, “different ridge lines” means completely different ridge lines or ridge lines with similar profiles but with offset positions of line variations. For instance, when the ridge line of a strip-shaped optical microstructure is a function curve formed by superimposing one or more sine functions, the ridge line of the strip-shaped optical microstructure may be controlled to have different initial phases but similar function forms.

Further, in this embodiment, as shown in FIG. 2A, the first height difference (or the second height difference) between the highest position and the lowest position of the first center line CL1 of each first strip-shaped optical microstructure 110 (or the second center line CL2 of each second strip-shaped optical microstructure 120) refers to a height difference between a highest point and a lowest point of the ridge line of the same first strip-shaped optical microstructure 110 (or the same second strip-shaped optical microstructure 120). The first difference (or the second difference) between the highest positions of the first center lines CL1 of any two of the first strip-shaped optical microstructures 110 (or the second center lines CL2 of any two of the second strip-shaped optical microstructures 120) refers to a height difference between the highest point of the ridge line of one first strip-shaped optical microstructure 110 (second strip-shaped optical microstructure 120) and the highest position of the ridge line of another first strip-shaped optical microstructure 110 (second strip-shaped optical microstructure 120). In addition, in this embodiment, an absolute value of a slope of a tangent line at each point on the ridge line of any first strip-shaped optical microstructure 110 and an absolute value of a slope of a tangent line at each point on the ridge line of any second strip-shaped optical microstructure 120 ranges between 0 and 1.2. It is particularly noted that the abovementioned height differences or height difference is, for example, the difference in distance of the highest point (or lowest point) relative to a virtual plane, where the virtual plane is, for example, parallel to the first direction D1 and the second direction D2 (or the plane of the optical film substrate where the first strip-shaped optical microstructures 110 are arranged).

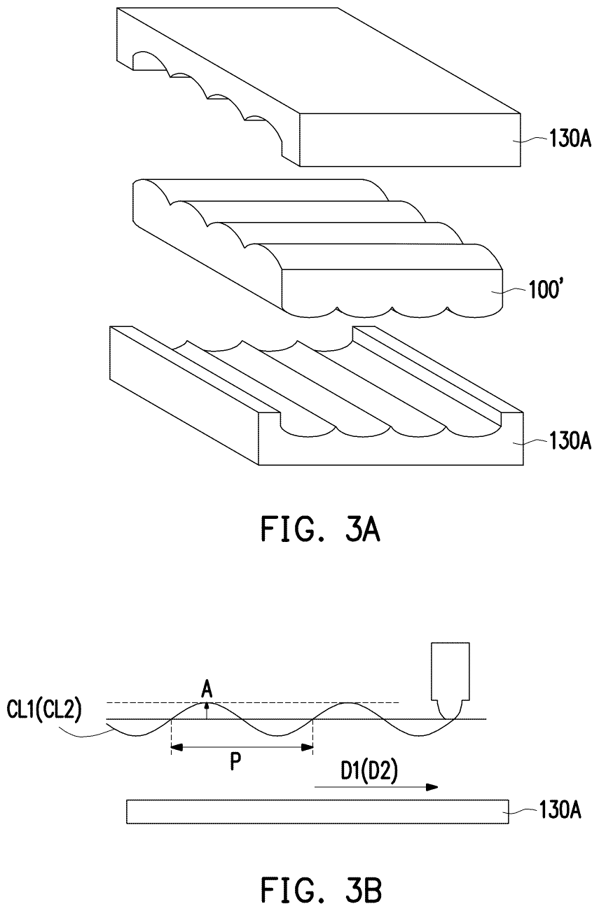

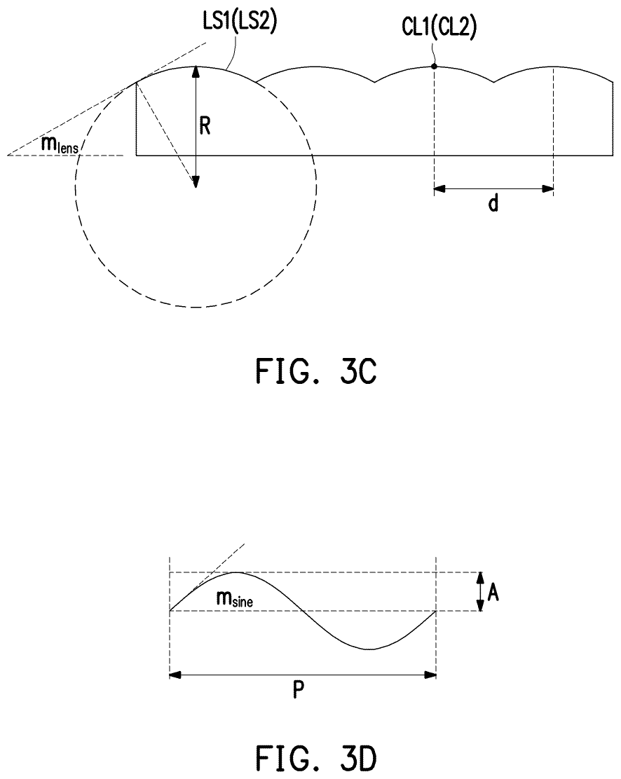

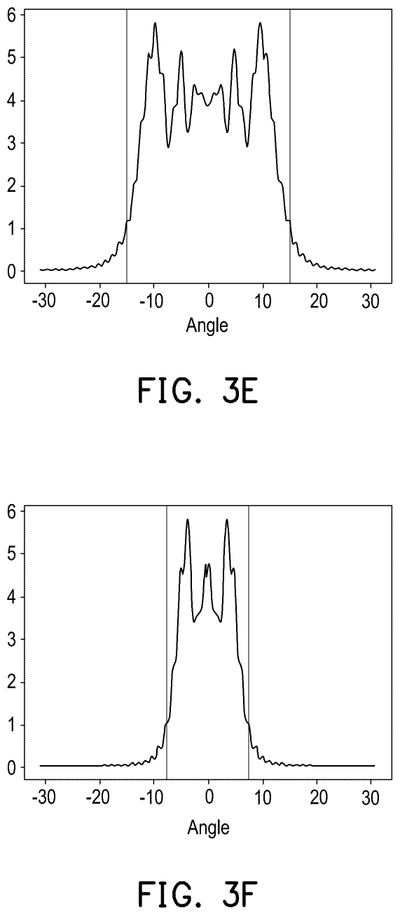

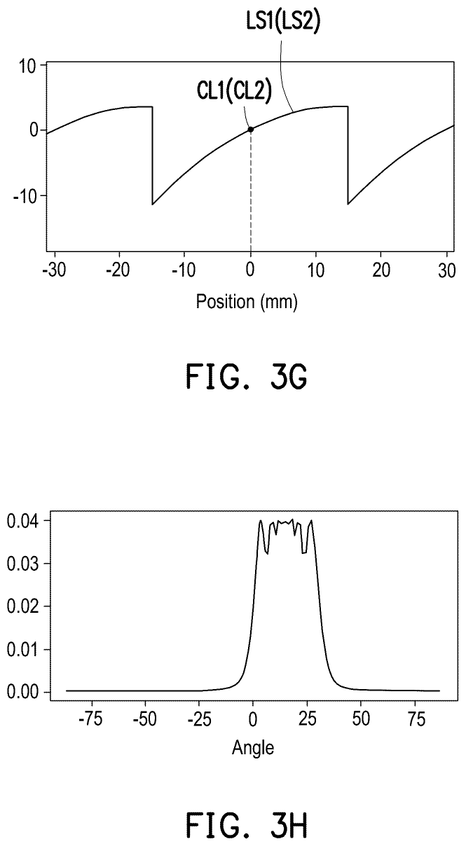

In the following, the formation method of the first strip-shaped optical microstructures 110 and the second strip-shaped optical microstructures 120 and the formation of their structural features are to be further explained with reference to FIG. 3A to FIG. 3H.

FIG. 3A to FIG. 3D are schematic views of forming a mold of the optical device 100 of FIG. 2A by machining with a tool. FIG. 3E and FIG. 3F are graphs of intensity distribution of diffused light with different lens radii. FIG. 3G is a schematic graph of a profile of another optical device 100 of FIG. 1A and FIG. 1B. FIG. 3H is a graph of intensity distribution of diffused light of the optical device 100 of FIG. 3G.

First, as shown in FIG. 3A, a one-dimensional cutting method may be used to make a mold 130A for forming a lenticular lens array (one-dimensional array, strip-shaped optical microstructures). The mold 130A may process an optical film plate body to form strip-shaped optical microstructures on surfaces of the optical film plate body, so as to produce an optical device 100′. This is easier to process than making a mold that forms a two-dimensional micro lens array. It is particularly noted that the optical film plate body is, for example, a flat substrate, and a surface of the flat substrate is hot-pressed by the mold. The abovementioned virtual plane is, for example, parallel to the first direction D1 and the second direction D2, and the lowest point of each strip-shaped optical microstructure is located on the virtual plane. Alternatively, the optical film plate body is a flat substrate with an optical adhesive arranged on it, and the optical adhesive is embossed by the mold and then cured by UV light. The above-mentioned virtual plane is, for example, the surface of the flat substrate where the optical adhesive is arranged. Both of the above methods may form the optical device 100′ including the first strip-shaped optical microstructures, the second strip-shaped optical microstructures, and the optical film substrate. Further, by arranging the first optical surface OP1 and the second optical surface OP2 on the surfaces of the optical device 100′ respectively, diffusion effects in different dimensional directions may be controlled. Therefore, different design parameters (such as radius and period) of the strip-shaped optical microstructures may be independently selected and combined to produce optical film substrates with different horizontal or vertical diffusion angles. Sharing the same mold can further reduce costs.

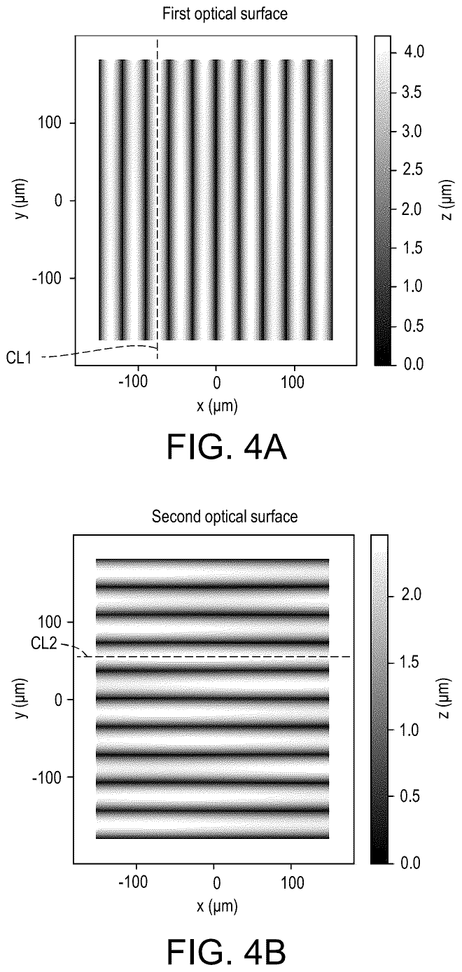

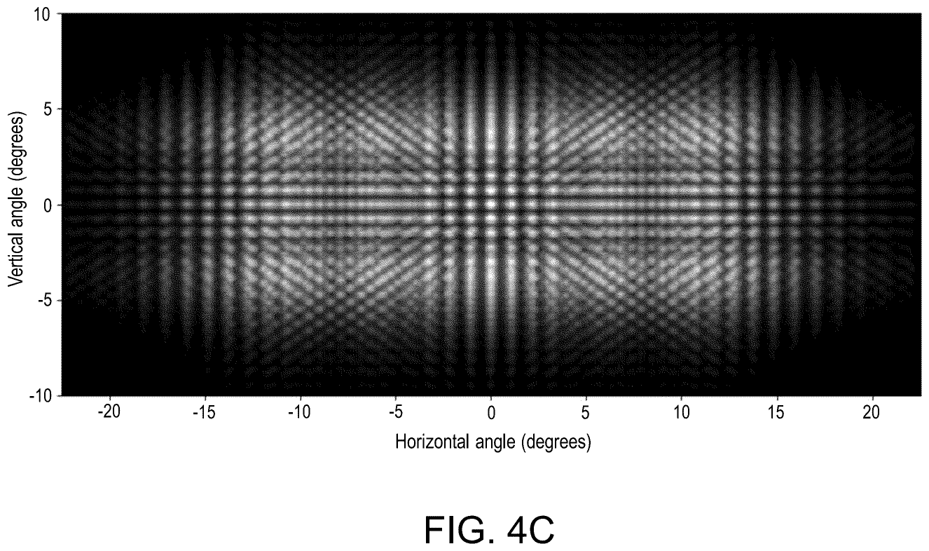

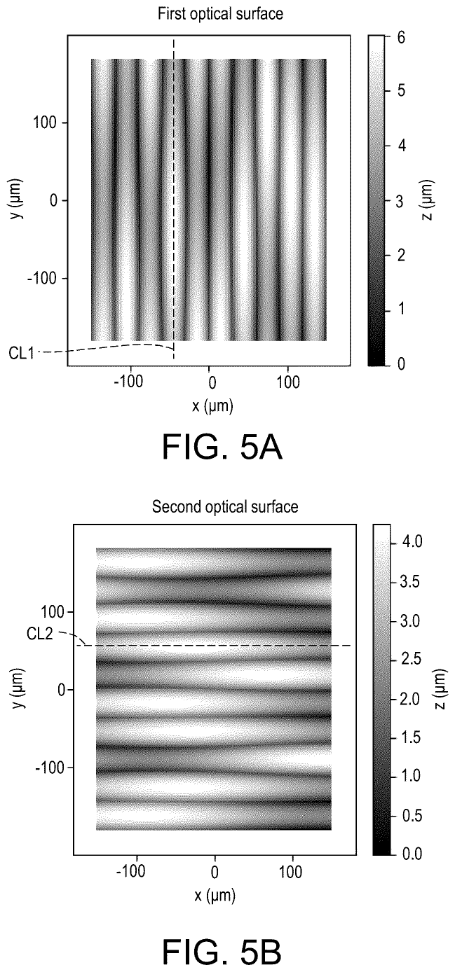

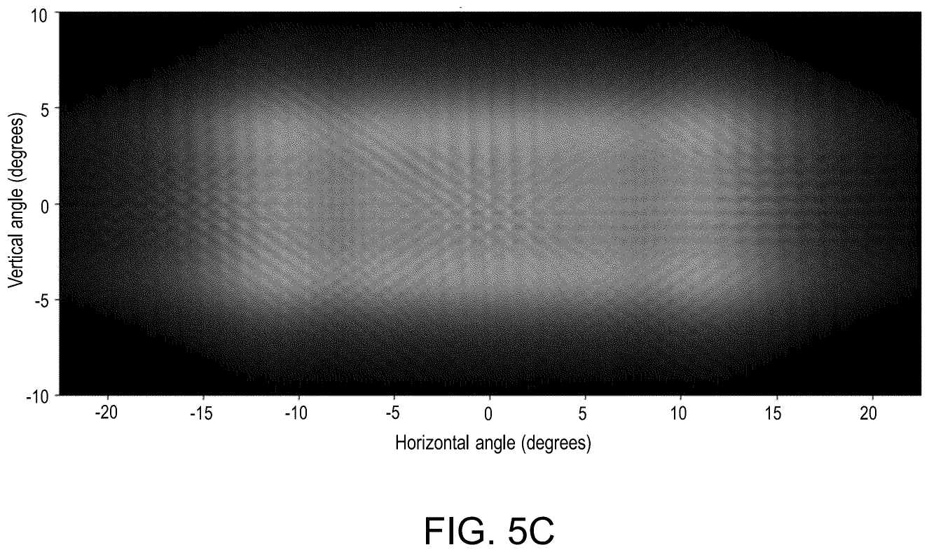

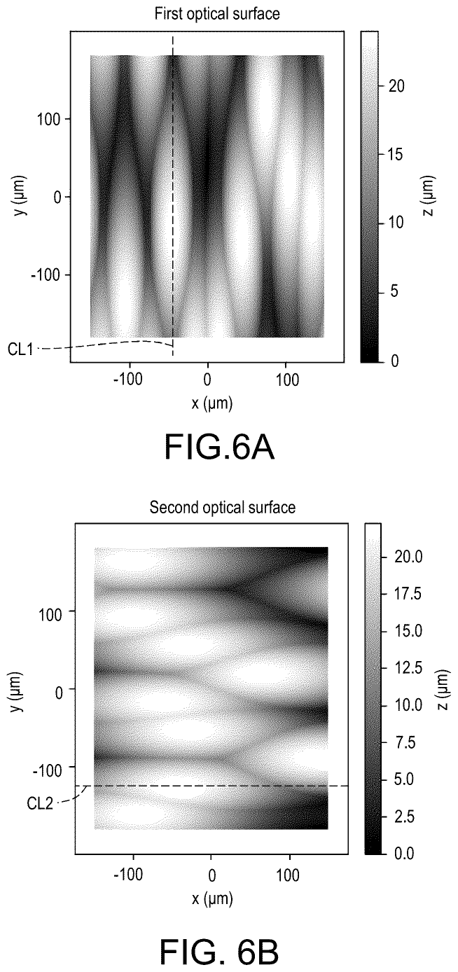

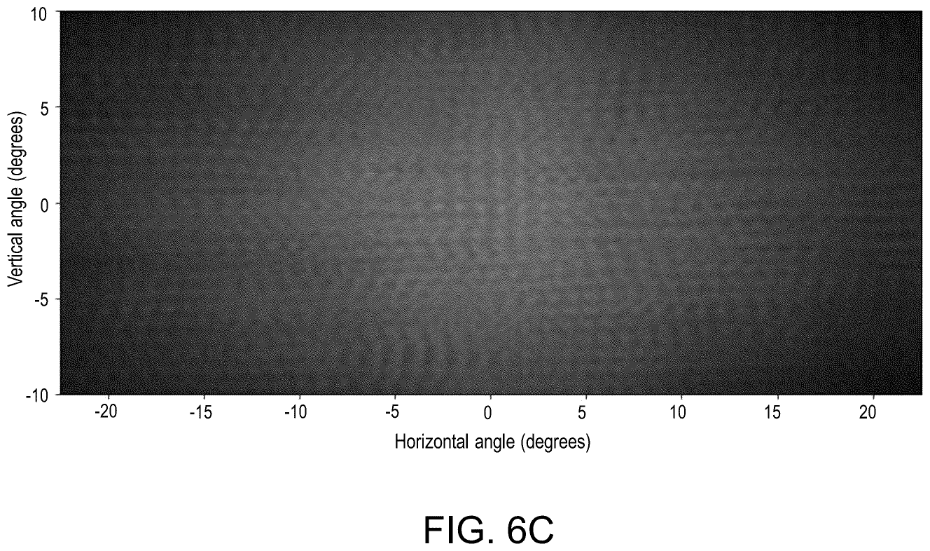

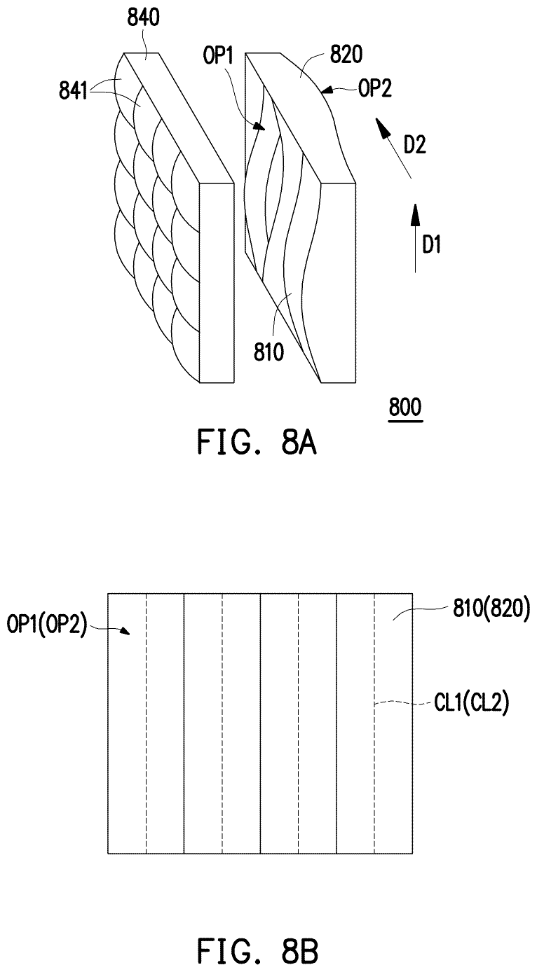

Next, as shown in FIG. 3B, in this embodiment, in a mold manufacturing process, the surface for forming the first strip-shaped optical microstructures 110 or the second strip-shaped optical microstructures 120 is subjected to a cutting modification in a height direction. In this way, heights and/or widths of the first strip-shaped optical microstructures 110 and the second strip-shaped optical microstructures 120 may be slightly changed without affecting distribution of diffusion angles of light rays. It is particularly noted that since this embodiment involves a cutting modification in the height direction, when viewing the optical device 100′ from above (as shown in the following FIG. 4A, FIG. 6A and FIG. 8B), the first center line CL1 (or the second center line CL2, i.e., the ridge line) is a straight line (i.e., orthogonal projection lines (or linear trend lines) of the first center line CL1 and the second center line CL2 are parallel to the first direction D1 and the second direction D2 respectively). As such, the light rays penetrating through the optical device 100′ may have different phases when penetrating through each individual first strip-shaped optical microstructure 110 and second strip-shaped optical microstructure 120. Further, the height difference between the highest position and the lowest position of the first center line CL1 of each first strip-shaped optical microstructure 110 (or the second center line CL2 of each second strip-shaped optical microstructure 120), or the difference between the highest positions of the center lines of any two strip-shaped optical microstructures) is greater than or equal to the predetermined value. In this way, diffracted light of the light rays in a far field may not show interference fringes, the influence of uniformity deterioration is suppressed, and the uniformity is thereby improved. In another embodiment, in the mold manufacturing process, the surface for forming the first strip-shaped optical microstructures 110 or the second strip-shaped optical microstructures 120 is subjected to a cutting modification may also be added in a width direction (when viewing the optical device 100′ from above, the ridge line is, for example, a curve, and the first direction D1 is parallel to, for example, the linear trend line of the orthogonal projection line of the first center line CL1). In yet another embodiment, in a mold cutting process, when only a minor cutting modification in the height direction (e.g., the height difference between the highest position and the lowest position of the first center line CL1 less than the predetermined value) or no cutting modification in the height direction are performed, the difference between the highest positions of the center lines of any two strip-shaped optical microstructures is made greater than or equal to the predetermined value. In this way, the distribution the diffracted light of the light rays in the far field may not show interference fringes, the influence of uniformity deterioration is suppressed, and the uniformity is thereby improved.

On the other hand, as shown in FIG. 3C, in this embodiment, at least one of the first lens surface profile LS1 of the first strip-shaped optical microstructures 110 and the second lens surface profile LS2 of the second strip-shaped optical microstructures 120 is an arc, which may be designed according to the following relationship:

$$R = \frac{d ( n - 1 )}{2 sin θ} ,$$

where R is a radius of curvature of the arc, θ is a diffusion angle of light expected to pass through the optical device 100, d is a structural period of the strip-shaped optical microstructures (i.e., the widths (pitch) of the first strip-shaped optical microstructures 110 or the second strip-shaped optical microstructures 120 in an arrangement direction), and n is an equivalent refractive index of the strip-shaped optical microstructures. Further, in this embodiment, functions of the first strip-shaped optical microstructures 110 and the second strip-shaped optical microstructures 120 are mainly to control the diffusion angle of the light passing through the optical device 100. For instance, optical performances (luminance of light output at various angles) of the optical device of different embodiments are shown in FIG. 3E and FIG. 3F. Taking the structural period (pitch) d of the first strip-shaped optical microstructures 110 and the second strip-shaped optical microstructures 120 as 30 μm and the equivalent refractive index of each of the first strip-shaped optical microstructures 110 and each of the second strip-shaped optical microstructures 120 as 1.5 as an example, When the radius of curvature R of the arc of the first lens surface profile LS1 or the second lens surface profile LS2 is set to 30 μm or 60 μm, a diffusion angle (for example, luminance is greater than 20% of maximum luminance) of 15 degrees (±15 degrees) or 7 degrees (±7 degrees) can be formed, respectively.

On the other hand, as shown in FIG. 3G and FIG. 3H, in this embodiment, the diffusion angle may be shifted by tilting the first lens surface profile LS1 or the second lens surface profile LS2. For instance, as shown in FIG. 3G and FIG. 3H, in this embodiment, when a slope of a line connecting one end and the other end of the first lens surface profile LS1 or the second lens surface profile LS2 relative to a horizontal direction is 0.5, its diffusion angle may be shifted by 15 degrees (for example, a center direction of a distribution of light output is shifted from 0 degrees to 15 degrees), so that the distribution of light output forms an asymmetric distribution relative to a normal viewing angle (0 degrees).

In addition, as shown in FIG. 3D, in this embodiment, a cutting tool may be made to oscillate in height according to a function curve formed by superimposing one or more sine functions. This causes slight changes in the height (or height and width) of the first strip-shaped optical microstructures 110 and the second strip-shaped optical microstructures 120 to modulate the phase of the light rays passing through, so uniformity is improved. In order to ensure that a phase difference of light rays passing through different microstructures has a sufficient difference, a maximum difference of a height change is greater than or equal to λ/[2(n−1)]. Taking the aforementioned λ as 400 nm, and the equivalent refractive index of each first strip-shaped optical microstructure 110 or each second strip-shaped optical microstructure 120 as 1.5 for example, the height change needs to be at least 0.4 μm. Considering that benefits of the height change may be evenly distributed between the first optical surface OP1 and the second optical surface OP2, and the maximum difference of the height change is typically twice an amplitude A (as shown in FIGS. 3B and 3D), as such, in this embodiment, the amplitude A may be set to be greater than or equal to 0.1 μm. Further, in another embodiment, by making the cutting tool oscillate in width, an oscillation amplitude of the cutting tool needs to be less than the structural period d of the first strip-shaped optical microstructures 110 and the second strip-shaped optical microstructures 120. Additionally, in this embodiment, a period P of a curve formed by the oscillation amplitude is between 100 μm and 1000 μm, preferably 500 μm. Further, for different positions of the first strip-shaped optical microstructures 110 or the second strip-shaped optical microstructure 120, an initial phase of the curve formed by the oscillation amplitude of the cutting tool may be changed, so the effect of uniform diffusion of light rays without obvious diffraction patterns can be achieved. Further, using the function curve superimposed with sine functions as the oscillation curve can be naturally formed by simply vibrating the tool at a specific frequency while cutting the mold structure, making it easy to process. However, the disclosure is not limited thereto. In other embodiments, the curve formed by the oscillation amplitude may also be other feasible surface variation function curves.

Therefore, the machined mold 130A may be used to form the first optical surface OP1 or the second optical surface OP2 of the optical film substrate 130 of the optical device 100 in FIG. 2A, so that the overall structure of each first strip-shaped optical microstructure 110 or each second strip-shaped optical microstructure 120 still presents a one-dimensional lenticular lens profile, but its surface height fluctuates slightly, and boundaries of the first lens surface profile LS1 and the second lens surface profile LS2 also have corresponding width changes.

In this way, in the display system 200 and the optical device 100, by slightly changing the height or width of the first strip-shaped optical microstructures 110 and the second strip-shaped optical microstructures 120, the light rays passing through the optical device 100 may have different phases after passing through different first strip-shaped optical microstructures 110 and the second strip-shaped optical microstructures 120. In this way, the distribution of the diffracted light of the light rays in the far field may not show interference fringes, the influence of uniformity deterioration is suppressed, and the uniformity is thereby improved.

In addition, it is worth noting that in this embodiment, in order to avoid additional height changes or width changes causing light rays passing through the optical device 100 to produce diffusion effects beyond expectations, which may cause light rays to diffuse beyond an originally designed range of diffusion angles, an upper limit may be set for the amplitude of the tool's oscillation. For instance, in optics, it can be considered that a maximum slope of the first lens surface profile LS1 of the first strip-shaped optical microstructures 110 and the second lens surface profile LS2 of the second strip-shaped optical microstructures 120 shall be greater than a maximum slope inherent to the curve formed by the tool's oscillation amplitude (i.e., a maximum slope of the ridge line of the first strip-shaped optical microstructures 110 or the second strip-shaped optical microstructures 120). Alternatively, it can be considered that the light deflection caused by the oscillation shall be less than the originally designed range of diffusion angles. Theoretically, these two considerations may impose the same limitation on the amplitude A, but they may also differ. When these two considerations impose different numerical limitations on the amplitude A, the larger one may be taken as the upper limit value for the amplitude A.

More specifically, in this embodiment, as shown in FIG. 3C and FIG. 3D, a maximum slope produced by a lens is approximately d/2R, where R is a radius of the first lens surface profile LS1 or the second lens surface profile LS2. The maximum slope of the curve formed by the oscillation amplitude is approximately 2πA/P, where P is the period of the curve formed by the oscillation amplitude. Therefore, it may be derived that the amplitude A is less than dP/4πR. Taking R as 30 μm, the structural period d of the first strip-shaped optical microstructures 110 or the second strip-shaped optical microstructures 120 as 30 μm, and the period of the curve formed by the oscillation amplitude as 500 μm as an example, the upper limit of the amplitude A is approximately 40 μm. However, for the case of the originally designed range of diffusion angles, such as when designed to approach Lambertian light distribution, it may not be necessary to set an upper limit for the amplitude A.

Further, in this embodiment, to achieve the best effect in improving uniformity, the height of each first strip-shaped optical microstructure 110 or each second strip-shaped optical microstructure 120, the oscillation period during cutting, the oscillation amplitude, the function of the oscillation, the initial phase of the sine wave, etc., may all adopt different control parameters or different combinations of control parameters. Since the combination and selection of the above parameters have a high degree of freedom, various wave optics simulation methods may be used to simulate the results of diffused light, such as the Fourier optics-amplitude spectrum method, the beam propagation method, the finite-difference time-domain (FDTD) method, and other wave optics calculation methods, so as to simulate and optimize parameters close to the required light energy distribution.

For instance, FIG. 4A to FIG. 6C are top views, bottom views, and simulation graphs of illuminance distribution of various optical devices of FIG. 1A and FIG. 1B. FIG. 4A and FIG. 4B show the distribution of the structure height modifications when the amplitude A of the curve formed by the oscillation amplitude is 0.1 μm. FIG. 4C is a simulation graph showing the illumination distribution when the amplitude A of the curve formed by the oscillation amplitude is 0.1 μm. FIG. 5A and FIG. 5B show the distribution of the structure height modifications when the amplitude A of the curve formed by the oscillation amplitude is 1 μm. FIG. 5C is a simulation graph showing the illumination distribution when the amplitude A of the curve formed by the oscillation amplitude is 1 μm. FIG. 6A and FIG. 6B show the distribution of the structure height modifications when the amplitude A of the curve formed by the oscillation amplitude is 10 μm. FIG. 6C is a simulation graph showing the illumination distribution when the amplitude A of the curve formed by the oscillation amplitude is 10 μm. As shown in FIG. 4C, FIG. 5C, and FIG. 6C, when the amplitude A of the curve formed by the oscillation amplitude is 0.1 μm, it begins to affect uniformity, When the amplitude A is 1 μm, the uniformity is improved, and when the amplitude A is 10 μm, there is significant improvement.

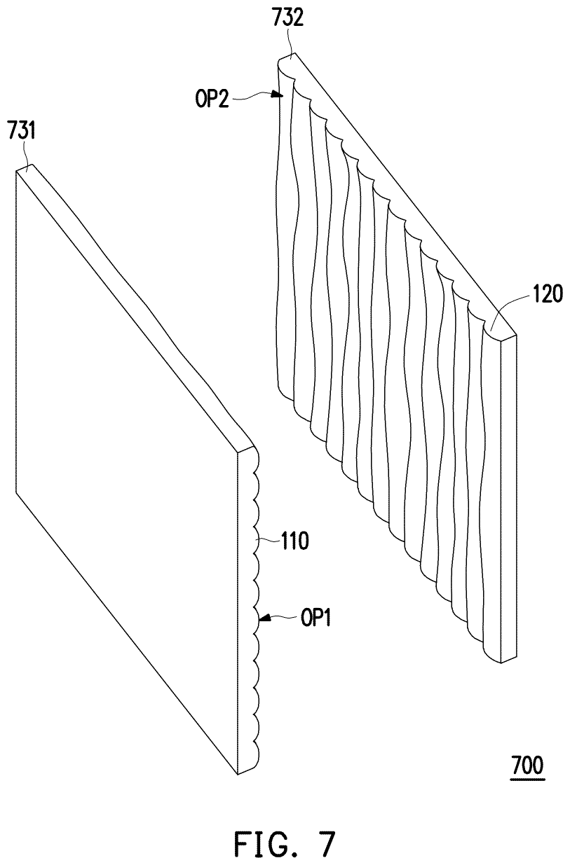

In addition, it is worth noting that in the aforementioned embodiments, although the first strip-shaped optical microstructures 110 or the second strip-shaped optical microstructures 120 of the optical device 100 are exemplified as being located on two opposite surfaces of the same optical film substrate 130, the disclosure is not limited thereto. In other embodiments, the first strip-shaped optical microstructures 110 or the second strip-shaped optical microstructures 120 of the optical device 100 may also be located on surfaces of different optical film substrates, and the aforementioned effects and advantages can still be achieved. Further explanation is provided in the following paragraphs together with FIG. 7 to FIG. 9.

Please refer to FIG. 7, in the embodiment of FIG. 7, an optical device 700 is similar to the optical device 100 of FIG. 2A, and the differences between the two are described as follows. As shown in FIG. 7, in this embodiment, the optical device 700 includes a first optical film substrate 731 and a second optical film substrate 732, and plural first strip-shaped optical microstructures 110 are located on the first optical film substrate 731, and plural second strip-shaped optical microstructures 120 are located on the second optical film substrate 732. In this embodiment, although the first optical surface OP1 and the second optical surface OP2 are exemplified as facing each other, the disclosure is not limited thereto. In other embodiments, the first optical surface OP1 and the second optical surface OP2 may also face away from each other.

Further, in this embodiment, in the optical device 700, by slightly changing the height or width of the first strip-shaped optical microstructures 110 and the second strip-shaped optical microstructures 120, the light rays passing through the optical device 700 may also have different phases after passing through different first strip-shaped optical microstructures 110 and the second strip-shaped optical microstructures 120. In this way, the distribution of the diffracted light of the light rays in the far field may not show interference fringes, the influence of uniformity deterioration is suppressed, and the uniformity is thereby improved. As such, when the optical device 700 is applied to the display system 200, it may also enable the display system 200 to achieve the aforementioned effects and advantages. Description thereof is not repeated herein.

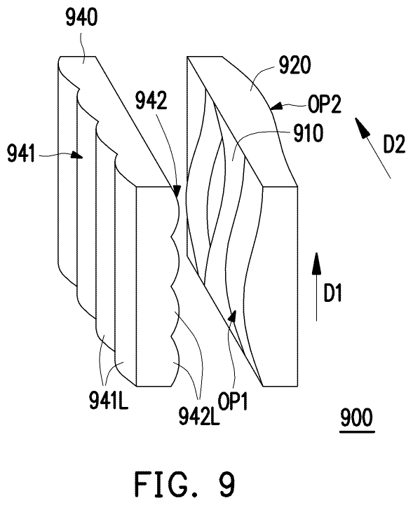

In addition, it is worth noting that in the aforementioned embodiments, although it is exemplified that a cutting tool is used to perform cutting and processing on the mold for forming the optical device 100, so as to form the first strip-shaped optical microstructures 110 and the second strip-shaped optical microstructures 120 that have both the lens surface profiles and slight changes in height or width, the disclosure is not limited thereto. In other embodiments, the optical device 100 may also achieve the aforementioned effects and advantages through forming a structure body that has strip-shaped optical microstructures with lens surface profile characteristics and strip-shaped optical microstructures with slight changes in height or width. Further explanation is provided in the following paragraphs together with FIG. 8A to FIG. 9.

FIG. 8A, FIG. 8B, and FIG. 9 are schematic views of structures of optical devices according to different embodiments of the disclosure. Please refer to FIG. 8A and FIG. 8B, in the embodiment of FIG. 8A and FIG. 8B, an optical device 800 of FIG. 8A is similar to the optical device 100 of FIG. 2A, and the differences between the two are described as follows. In this embodiment, first strip-shaped optical microstructures 810 and the second strip-shaped optical microstructures 820 do not have top surfaces with lens surface profiles, but only require height (or height and width) cutting and processing on the mold by the tool. The cutting and processing method is the same as described in the relevant paragraphs of FIG. 3B and FIG. 3D, so description thereof is not repeated herein. Accordingly, the first strip-shaped optical microstructures 810 with rectangular cross sections on the first plane orthogonal to the first direction D1 and the second strip-shaped optical microstructures 820 with rectangular cross sections on the second plane orthogonal to the second direction D2 (i.e., the profiles of the top surfaces of the first strip-shaped optical microstructures 810 and the second strip-shaped optical microstructures 820 are straight lines) may be formed. As shown in FIG. 8B, when viewing the strip-shaped optical microstructures from above, the center lines are straight lines and are, for example, the lines of symmetry of the strip-shaped optical microstructures. Further, as shown in FIG. 8A, the optical device 800 further includes a diffusing optical film 840 having a plurality of lens microstructures 841, and the lens microstructures 841 have a same shape. The lens microstructures 841 are arranged in a two-dimensional array on a surface of the diffusing optical film 840. The lens microstructures 841 constituting a plurality of columns in the two-dimensional array are arranged corresponding to one of the first strip-shaped optical microstructures 810 and the second strip-shaped optical microstructures 820, and the lens microstructures 841 constituting a plurality of rows in the two-dimensional array are arranged corresponding to the other of the first strip-shaped optical microstructures 810 and the second strip-shaped optical microstructures 820. Moreover, in this embodiment, boundaries of the lens microstructures 841 constituting the two-dimensional array overlap with boundaries of either the first strip-shaped optical microstructures 810 or the second strip-shaped optical microstructures 820. In addition, in this embodiment, the amplitude A of the curve formed by the oscillation amplitude is greater than or equal to λ/[8(n−1)].

On the other hand, in the embodiment of FIG. 9, an optical device 900 of FIG. 9 is similar to the optical device 800 of FIG. 8A, and the differences between the two are described as follows. In this embodiment, at least one diffusion optical film 940 of the optical device 900 has a plurality of first strip-shaped lens microstructures 941L (e.g., lenticular) and a plurality of second strip-shaped lens microstructures 942L (e.g., lenticular) arranged on two surfaces of the at least one diffusion optical film 940. Top surfaces of the first strip-shaped lens microstructures 941L and a second lens surface 942 form, for example, a first lens surface 941 and the second lens surface 942 respectively. The first strip-shaped lens microstructures 941L have a same shape, and the second strip-shaped lens microstructures 942L have a same shape. The first strip-shaped lens microstructures 941L are arranged corresponding to the first strip-shaped optical microstructures 810, and the second strip-shaped lens microstructures 942L are arranged corresponding to the second strip-shaped optical microstructures 820. Further, orthogonal projection regions of the first strip-shaped lens microstructures 941L completely overlap with that of the first strip-shaped optical microstructures 810, and orthogonal projection regions of the second strip-shaped lens microstructures 942L completely overlap with that of the second strip-shaped optical microstructures 820. It is particularly noted that similar to the embodiment of FIG. 7, the first strip-shaped optical microstructures 810 and the second strip-shaped optical microstructures 820 may be arranged on two optical film substrates, and the first strip-shaped lens microstructures 941L and the second strip-shaped lens microstructures 942L may be arranged on two diffusion optical films.

In this way, in the embodiments of FIG. 8A and FIG. 9, in the optical devices 800 and 900, by slightly changing the height or width of the first strip-shaped optical microstructures 810 and the second strip-shaped optical microstructures 820, the light rays passing through the optical devices 800 and 900 may also have different phases after passing through the first strip-shaped optical microstructures 810 and the second strip-shaped optical microstructures 820. In this way, the distribution of the diffracted light of the light rays in the far field may not show interference fringes, the influence of uniformity deterioration is suppressed, and the uniformity is thereby improved. As such, when the optical devices 800 and 900 are applied to the display system 200, it may also enable the display system 200 to achieve the aforementioned effects and advantages. Description thereof is not repeated herein.

In view of the foregoing, the embodiments of the disclosure have at least one of the following advantages or effects. In the embodiments of the disclosure, in the display system and the optical device, by slightly changing the height or width of the first strip-shaped optical microstructures and the second strip-shaped optical microstructures, the light rays passing through the optical device may have different phases after passing through the independent first strip-shaped optical microstructures and the second strip-shaped optical microstructures. In this way, the distribution of the diffracted light of the light rays in the far field may not show interference fringes, the influence of uniformity deterioration is suppressed, and the uniformity is thereby improved.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An optical device comprising a first optical surface, a second optical surface, a plurality of first strip-shaped optical microstructures, and a plurality of second strip-shaped optical microstructures, wherein
the first strip-shaped optical microstructures extend in a first direction, top surfaces of the first strip-shaped optical microstructures form the first optical surface, each of the first strip-shaped optical microstructures has a first center line, and a first height difference is provided between a highest position and a lowest position of each first center line, or a first difference is provided between the highest positions of any two of the first center lines, and
the second strip-shaped optical microstructures extend in a second direction, top surfaces of the second strip-shaped optical microstructures form the second optical surface, the first direction and the second direction are not parallel, each of the second strip-shaped optical microstructures has a second center line, and a second height difference is provided between a highest position and a lowest position of each second center line, or a second difference is provided between the highest positions of any two of the second center lines.

2. The optical device according to claim 1, wherein at least one of the first height difference and the first difference is greater than or equal to a predetermined value, at least one of the second height difference and the second difference is greater than or equal to the predetermined value, and the predetermined value ranges between λ/[4(n−1)] and 4λ/(n−1), where λ is a minimum working wavelength of light preset to pass through the optical device, and n is an equivalent refractive index of each of the first strip-shaped optical microstructures or each of the second strip-shaped optical microstructures.

3. The optical device according to claim 1, wherein the first center line of any one of the first strip-shaped optical microstructures and the second center line of any one of the second strip-shaped optical microstructures are function curves formed by superimposing one or a plurality of sine functions or non-periodic function curves, the first center line curves of adjacent first strip-shaped optical microstructures are different, and the second center line curves of adjacent second strip-shaped optical microstructures are different.

4. The optical device according to claim 1, wherein an absolute value of a slope of a tangent line at each point on the first center line of any one of the first strip-shaped optical microstructures and an absolute value of a slope of a tangent line at each point on the second center line of any one of the second strip-shaped optical microstructures range between 0 and 1.2.

5. The optical device according to claim 1, wherein
cross sections of the first strip-shaped optical microstructures on a first plane orthogonal to the first direction are first lens surface profiles, cross sections of the second strip-shaped optical microstructures on a second plane orthogonal to the first direction are second lens surface profiles, and at least one of the first lens surface profiles and the second lens surface profiles is an arc, a parabola, or a free curve.

6. The optical device according to claim 1, wherein the optical device further comprises an optical film substrate, and the first strip-shaped optical microstructures and the second strip-shaped optical microstructures are located on two opposite surfaces of the optical film substrate.

7. The optical device according to claim 1, wherein the optical device further comprises a first optical film substrate and a second optical film substrate, the first strip-shaped optical microstructures are located on the first optical film substrate, and the second strip-shaped optical microstructures are located on the second optical film substrate.

8. The optical device according to claim 1, wherein a cross section of each first strip-shaped optical microstructure on a first plane orthogonal to the first direction is a rectangle, a cross section of each second strip-shaped optical microstructure on a second plane orthogonal to the first direction is a rectangle, and the optical device further comprises at least one diffusion optical film, wherein
the at least one diffusion optical film has a plurality of first strip-shaped lens microstructures and a plurality of second strip-shaped lens microstructures, the first strip-shaped lens microstructures are arranged corresponding the first strip-shaped optical microstructures, and the second strip-shaped lens microstructures are arranged corresponding to the second strip-shaped optical microstructures.

9. The optical device according to claim 1, wherein a cross section of each first strip-shaped optical microstructure on a first plane orthogonal to the first direction is a rectangle, a cross section of each second strip-shaped optical microstructure on a second plane orthogonal to the first direction is a rectangle, and the optical device further comprises a diffusion optical film, wherein
the diffusion optical film has a plurality of lens microstructures, the lens microstructures are arranged in a two-dimensional array on the diffusion optical film, the lens microstructures constituting a plurality of columns in the two-dimensional array are arranged corresponding to one of the first strip-shaped optical microstructures and the second strip-shaped optical microstructures, and the lens microstructures constituting a plurality of rows in the two-dimensional array are arranged corresponding to the other of the first strip-shaped optical microstructures and the second strip-shaped optical microstructures.

10. A display system comprising a projection device and an optical device, wherein
the projection device is configured to provide a projection light beam, and
the optical device is arranged on a transmission path of the projection light beam and has a first optical surface, a second optical surface, a plurality of first strip-shaped optical microstructures, and a plurality of second strip-shaped optical microstructures, wherein
the first strip-shaped optical microstructures extend in a first direction, top surfaces of the first strip-shaped optical microstructures form the first optical surface, each of the first strip-shaped optical microstructures has a first center line, and a first height difference is provided between a highest position and a lowest position of each first center line, or a first difference is provided between the highest positions of any two of the first center lines, and
the second strip-shaped optical microstructures extend in a second direction, top surfaces of the second strip-shaped optical microstructures form the second optical surface, the first direction and the second direction are not parallel, each of the second strip-shaped optical microstructures has a second center line, and a second height difference is provided between a highest position and a lowest position of each second center line, or a second difference is provided between the highest positions of any two of the second center lines.
